(19) United States
(12) Patent Application Publication
(10) Pub. No.: US 2007/0049685 A1
(43) Pub. Date: Mar. 1, 2007

(54) Thermoplastic polyurethanes

(75) Inventors: Jan-Gerd Hansel, Koln (DE); Eberhard Kuckert, Leverkusen (DE); Melanie Wiedemeier, Dormagen (DE)

Correspondence Address: LANXESS CORPORATION, 111 RIDC PARK WEST DRIVE, PITTSBURGH, PA, 15275-1112, US

(73) Assignee: LANXESS Deutschland GmbH

(21) Appl. No.: 11/506,724

(22) Filed: Aug. 18, 2006

(30) Foreign Application Priority Data
Aug. 25, 2005 (DE) 10 2005 040 131.7

(51) Int. Cl. C08G 18/08

(52) U.S. Cl. 524/589

(57) ABSTRACT

Soft, elastomeric, thermoplastic polyurethanes comprising, as plasticizer, a mixture composed of trimethylolalkane esters of aromatic carboxylic acids, of trimethylolalkane esters of aliphatic carboxylic acids, and also of trimethylolalkane esters of both aromatic and aliphatic carboxylic acids, a process for their production, and their use.

The present invention relates to soft, elastomeric, thermoplastic polyurethanes comprising, as plasticizer, a mixture composed of trimethylolalkane esters of aromatic carboxylic acids, of trimethylolalkane esters of aliphatic carboxylic acids, and also of trimethylolalkane esters of both aromatic and aliphatic carboxylic acids, and their use.

### BACKGROUND OF THE INVENTION

Thermoplastic polyurethane elastomers, abbreviated to TPUs below, have been known for a long time. Their industrial importance is based on combining high-value mechanical properties with the advantages of low-cost thermoplastic processing. A wide variety of mechanical properties can be achieved via use of different chemical structural components. An overview of TPUs and their properties, production and applications is given by way of example in Hans-Georg Wussow: “Thermoplastic Elastomers”, Ullmann's Encyclopedia of Industrial Chemistry, Electronic Release, 7th ed., chap. 2, “Thermoplastic Polyurethane Elastomers”, Wiley-VCH, Weinheim 2004.

TPUs can be produced continuously or batchwise by various processes. The best known, that known as the belt process, e.g. according to GB 1 057 018 A, and the extruder process, e.g. according to U.S. Pat. No. 3,642,964, are also utilized industrially.

TPUs are composed of linear polyhydroxy compounds, of aromatic diisocyanates, and of diols. Their hardness is adjusted by way of the content of what is known as a hard phase, which in essence consists of diisocyanate-diol segments. TPUs with hardnesses of from Shore A 85 to Shore D 74 can easily be produced via suitable selection of the molar ratios of the structural components. Although it is theoretically possible to obtain TPUs with Shore A hardness smaller than 85 in the same way, a disadvantage is that handling of the products during the production process is difficult, because they are extremely difficult to solidify.

Plasticizers can be incorporated into relatively hard TPUs in order to produce TPU materials with Shore A hardness smaller than 85. Dialkyl esters of phthalic acid are often described for this purpose. For example, DD 300 900 A7 proposes dibutyl phthalate and diethyl phthalate as plasticizers for TPU, EP 0 134 455 A1 (=CA 1 257 946) proposes di(methoxyethyl)phthalate, DE 41 12 805 A1 proposes di(methoxyethoxyethyl)phthalate, and EP 0 695 786 A1 proposes benzyl butyl phthalate. Benzyl butyl phthalate (BBP) is the most frequently used of the phthalates, but has proven to have developmental toxicity and possibly to impair reproduction. According to Directive 2004/73/EC, BBP must be labelled accordingly in Europe from 31 Oct. 2005. This risk considerably restricts the usefulness of benzyl butyl phthalate. Other phthalates, such as dibutyl phthalate or di-2-ethylhexyl phthalate, can also possibly have adverse physiological effects, and there is therefore a need for plasticizers for TPU which require no phthalate and, respectively, no labelling.

Using the plasticizers mentioned, it is possible to produce TPU preparations with low Shore A hardness and with good low-temperature flexibility. A precondition for easy processing is that the acid number of the plasticizers is smaller than 1 mg KOH/g and their viscosity is smaller than 1 000 mPas. The plasticizer should suffer no ill effects at processing temperatures from 180 to 220° C. Another important requirement is low plasticizer volatility. By way of example, the volatility of the phthalates causes what is known as fogging, i.e. condensation of evaporated volatile constituents from the motor vehicle interior trim on glass panes, in particular on the windscreen. This undesired phenomenon can be quantified to DIN 75 201 B via the amount of fogging condensate. Amounts of fogging condensates smaller than 1 mg to DIN 75 201 B are demanded from modern materials for motor-vehicle interior trim.

Furthermore, the plasticizer has a tendency toward migration into adjacent plastics and can be extracted by lubricants or solvents, the result being undesired gradual hardening of the TPU material. In particular when there is long lasting exposure to high temperatures, impairment of the mechanical properties of the plasticized TPUs can be observed. When plasticizers have inadequate compatibility with the TPU, undesired extrudation of the plasticizer at the surface of the TPU moulding occurs particularly on heating. This makes the moulding greasy and unusable. Even known phthalate-free plasticizers for TPU, e.g. the aryl phosphates described in EP 0 134 455 A1, the phenol alkanesulphonates described in EP 0 695 786 A1 and the dipropylene glycol dibenzoate described in W. D. Arendt, Elastomerics, 1980, 112 (6), pp. 24-33, represent only unsatisfactory solutions here.

The object of the present invention consisted in providing elastomeric TPU preparations with Shore A hardnesses smaller than 85 which comprise no phthalates and exhibit a very low level of fogging. The resultant TPUs should moreover be capable of processing by known methods to give foils or mouldings, without any sticking or handling difficulty in the process.

### SUMMARY OF THE INVENTION

Surprisingly, it has now been possible to achieve this object via addition of amounts of up to 50% by weight of selected plasticizer mixtures to conventional TPUs.

The present invention provides polyurethane preparations comprising from 50 to 99% by weight of a polyurethane and from 1 to 50% by weight of a plasticizer mixture comprising trimethylolalkane esters of aromatic carboxylic acids, trimethylolalkane esters of aliphatic carboxylic acids and trimethylolalkane esters of both aromatic and aliphatic carboxylic acids.

In one particular embodiment, the present invention provides polyurethane preparations where the polyurethane is a thermoplastic polyurethane elastomer (TPU).

In one particularly preferred embodiment, the present invention provides TPU preparations comprising
A) from 50 to 99% by weight of a TPU, produced from
   1) organic diisocyanates,
   2) substantially dihydric polyhydroxy compounds with molar masses of from 500 to 8 000 g/mol,
   3) chain extenders with molar masses of from 60 to 400 g/mol,
   4) optionally auxiliaries, additives and/or fillers, and
B) from 1 to 50% by weight of a plasticizer mixture comprising trimethylolalkane esters of aromatic carboxylic acids, trimethylolalkane esters of aliphatic carboxylic acids and trimethylolalkane esters of both aromatic and aliphatic carboxylic acids as plasticizers.

The inventive polyurethane preparations or inventive elastomeric TPUs whose Shore A hardness is 80 and below, preferably whose Shore A hardness is from 80 to 60, advantageously have, as main plastic A), thermoplastic polyurethanes whose Shore A hardness is from 95 to 80, preferably whose Shore A hardness is from 85 to 80.

Preferred organic diisocyanates (1) used are aliphatic, cycloaliphatic or aromatic diisocyanates. Hexamethylene diisocyanate is particularly preferably used as aliphatic diisocyanates. Particularly preferred cycloaliphatic diisocyanates used are isophorone diisocyanate, cyclohexane-1,4-diisocyanate, 1-methylcyclohexane 2,4- and 2,6-diisocyanate, and also their corresponding isomer mixtures, dicyclohexylmethane 4,4′-, 2,4′- and 2,2′-diisocyanate, and also their corresponding isomer mixtures. Particularly preferred aromatic diisocyanates used are tolylene 2,4-diisocyanate, mixtures composed of tolylene 2,4- and 2,6-diisocyanate, diphenylmethane 4,4′-, 2,4′- and 2,2′-diisocyanate, mixtures composed of diphenylmethane 2,4′- and 4,4′-diisocyanate, urethane-modified liquid diphenylmethane 4,4′- and/or 2,4′-diisocyanates, 4,4′-diisocyanato-1,2-diphenylethane, 3,3′-dimethylbiphenyl 4,4′-diisocyanate, phenylene 1,4-diisocyanate or naphthylene 1,5-diisocyanate. It is particularly preferable to use hexamethylene 1,6-diisocyanate, isophorone diisocyanate, diphenylmethane diisocyanate isomer mixtures whose diphenylmethane 4,4′-diisocyanate content is greater than 96% by weight and in particular diphenylmethane 4,4′-diisocyanate and naphthylene 1,5-diisocyanate.

Preferably suitable substantially dihydric polyhydroxy compounds (2) whose molar masses are from 500 to 8 000 g/mol are polyetherols and in particular polyesterols. However, use may also be made of polymers containing hydroxy groups and having molar masses of from 500 to 8 000 g/mol, e.g. polyacetales, such as polyoxymethylenes, and especially formals which are insoluble in water and have the abovementioned molar masses, e.g. polybutanediol formal and polyhexanediol formal, and polycarbonates, in particular those derived from diphenyl carbonate and 1,6-hexanediol, obtainable via transesterification. The polyhydroxy compounds mentioned can be used in the form of individual components or in the form of mixtures.

Suitable polyetherols can be prepared by reacting one or more alkylene oxides having from 2 to 4 carbon atoms in the alkylene radical with a starter molecule which contains two active hydrogen atoms. Examples which may be mentioned of alkylene oxides are ethylene oxide, propylene 1,2-oxide, epichlorohydrin and butylene 1,2- and 2,3-oxide.

It is preferable to use ethylene oxide and mixtures composed of propylene 1,2-oxide and ethylene oxide. The alkylene oxides can be used individually, in alternating succession, or in the form of mixtures. Examples of starter molecules that can be used are: water, aminoalcohols, such as N-alkyldiethanolamines, e.g. N-methyldiethanolamine, and diols, such as ethylene glycol, propylene 1,3-glycol, 1,4-butanediol and 1,6-hexanediol. It is also possible, if appropriate, to use mixtures of starter molecules. Other suitable polyetherols are the polymerization products of tetrahydrofuran which contain hydroxy groups.

It is preferable to use polytetramethylene ether glycols and polyetherols derived from propylene 1,2-oxide and ethylene oxide, where more than 50%, preferably from 60 to 80%, of the OH groups in these are primary hydroxy groups, and where at least a portion of the ethylene oxide in these has been arranged as a terminal block.

Polyetherols of this type can be obtained by, for example, first polymerizing the propylene 1,2-oxide onto the starter molecule, and then the ethylene oxide onto this material, or first copolymerizing all of the propylene 1,2-oxide in a mixture with a portion of the ethylene oxide and then polymerizing the remainder of the ethylene oxide onto this material, or, stepwise, first polymerizing a portion of the ethylene oxide onto the starter molecule and then all of the propylene 1,2-oxide, and then the remainder of the ethylene oxide.

The substantially linear polyetherols have molar masses of from 500 to 8 000 g/mol, preferably from 600 to 6 000 g/mol and in particular from 1 000 to 4 000 g/mol. They can be used either individually or else in the form of mixtures with one another.

Suitable polyesterols can, for example, be prepared from dicarboxylic acids having from 2 to 12 carbon atoms, preferably from 4 to 6 carbon atoms, and from polyhydric alcohols. Examples of dicarboxylic acids that can be used are: aliphatic dicarboxylic acids, such as succinic acid, glutaric acid, adipic acid, suberic acid, azelaic acid and sebacic acid, and aromatic dicarboxylic acids, such as phthalic acid, isophthalic acid and terephthalic acid. The dicarboxylic acids can be used individually or in the form of mixtures, e.g. in the form of a mixture comprising succinic, glutaric and adipic acid. In order to prepare the polyesterols it can sometimes be advantageous to use the corresponding dicarboxylic acid derivatives instead of the dicarboxylic acids, examples being diesters of carboxylic acids having from 1 to 4 carbon atoms in the alcohol radical, or anhydrides or chlorides of carboxylic acids. Preferred polyhydric alcohols are glycols having from 2 to 10, preferably from 2 to 6, carbon atoms, particularly preferably ethylene glycol, diethylene glycol, 1,4-butanediol, 1,5-pentanediol, 1,6-hexanediol, 1,10-decanediol, 2,2-dimethyl-1,3-propanediol, 1,3-propanediol or dipropylene glycol. As a function of the properties desired, the polyhydric alcohols can be used alone or, if appropriate, in mixtures with one another.

Other suitable compounds are esters of carbonic acid with the diols mentioned, in particular with those having from 4 to 6 carbon atoms, such as 1,4-butanediol and/or 1,6-hexanediol, condensates of ω-hydroxycarboxylic acids, such as ω-hydroxycaproic acid, and preferably polymerization products of lactones, e.g. of unsubstituted or substituted ω-caprolactones.

Preferred polyesterols used are ethanediol polyadipates, 1,4-butanediol polyadipates, ethanediol butanediol 1,4-polyadipates, 1,6-hexanediol neopentyl glycol polyadipates, 1,6-hexanediol 1,4-butanediol polyadipates and polycaprolactones.

The molar masses of the polyesterols are from 500 to 6 000 g/mol, preferably from 1 000 to 4 000 g/mol.

Chain extenders (3) used whose molar masses are from 60 to 400 g/mol, preferably from 60 to 300 g/mol, are preferably aliphatic diols having from 2 to 12 carbon atoms, preferably having 2, 4 or 6 carbon atoms, particularly preferably ethanediol, 1,6-hexanediol, diethylene glycol, dipropylene glycol and in particular 1,4-butanediol. However, other suitable compounds are diesters of terephthalic acid with glycols having from 2 to 4 carbon atoms, preferably bis(ethylene glycol)terephthalate or bis(1,4-butanediol)terephthalate, hydroxyalkylene ethers of hydroquinone, preferably 1,4-di(β-hydroxyethyl)hydroquinone, (cyclo)aliphatic diamines, preferably isophoronediamine, ethylenediamine, propylene-1,2- and -1,3-diamine, N-methylpropylene-1,3-diamine, N,N′-dimethylethylenediamine or aromatic diamines, preferably tolylene-2,4- and 2,6-diamine, 3,5-diethyltolylene-2,4- and/or 2,6-diamine and primary ortho-, di-, tri- and/or tetraalkyl-substituted 4,4′-diaminodiphenylmethanes. It is also possible to use mixtures of the chain extenders mentioned.

In order to adjust hardness and melting point of the TPUs, the molar ratios of the structural components (2) and (3) can be varied relatively widely. Molar ratios of polyhydroxy compounds (2) to chain extenders (3) of from 1:1 to 1:12, in particular from 1:1.8 to 1:4.4, have proven successful, and the hardness and the melting point of the TPUs here rises with increasing content of diols.

To prepare the TPUs, the structural components (1), (2) and (3) are reacted in the presence of auxiliaries (4), e.g. catalysts, in amounts such that the ratio of equivalents of NCO groups in the diisocyanates to the entirety of the hydroxy groups or hydroxy and amino groups of components (2) and (3) is from 1:0.85 to 1.20, preferably 1:0.95 to 1:1.05 and in particular about 1:1.02.

Suitable catalysts which in particular accelerate the reaction between the NCO groups of the diisocyanates (1) and the hydroxy groups of the structural components (2) and (3) are the known and conventional tertiary amines of the prior art, preferably triethylamine, dimethylcyclohexylamine, N-methylmorpholine, N,N′-dimethylpiperazine, 2-(dimethyl-aminoethoxy)ethanol, diazabicyclo[2.2.2]octane and the like, and also in particular organometallic compounds, preferably titanic esters, iron compounds, tin compounds, such as stannous diacetate, stannous dioctoate, stannous dilaurate or the dialkyltin salts of aliphatic carboxylic acids, e.g. dibutyltin diacetate, dibutyltin dilaurate or the like. The amounts usually used of the catalysts are from 0.001 to 0.1 part per 100 parts of polyhydroxy compound.

Other materials which may be added alongside the catalysts to the structural components are other auxiliaries, additives and/or fillers (4). Mention may be made by way of example of lubricants, inhibitors, stabilizers with respect to hydrolysis, light, heat or discolouration, microbiocides, flame retardants, dyes, pigments, inorganic and/or organic fillers, blowing agents and reinforcing agents.

Further details concerning the abovementioned auxiliaries can be found in the technical literature, e.g. in Kunststoff-Handbuch [Plastics Handbook], Volume 7 “Polyurethane”, edited by G. Oertel, new edition edited by G. W. Becker and D. Braun, Carl-Hanser-Verlag, Munich, 3rd Edition 1993, pp. 104-127, pp. 455-467 or DE-A 29 01 774.

The plasticizer mixture (B) of the inventive TPUs comprises at least the following substances:
a) one compound of the general formula (I) 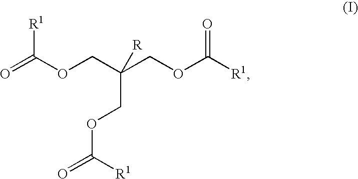
in which
   R is H or a C₁-C₄-alkyl chain and
   R¹ is a C₆-C₁₄-aryl radical, unsubstituted or substituted with from one to three C₁-C₄-alkyl radicals,
b) a compound of the general formula (II) 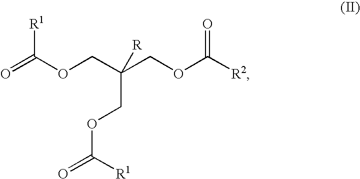
in which
   R and R¹ are as defined above and
   R² is a straight-chain or branched C₇-C₂₁-alkyl radical,
c) a compound of the general formula (III) 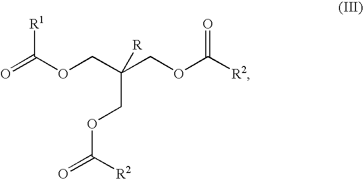
in which
   R, R¹ and R² are as defined above and
d) a compound of the general formula (IV) 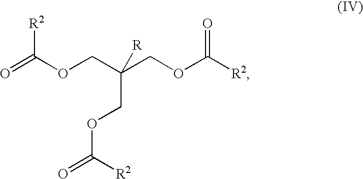
in which
   R and R² are as defined above.

The radical R preferably derives from trimethylolalkanes of the general formula (V) 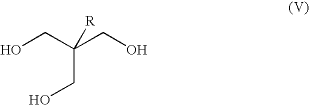
in which
R is H or a C₁-C₄-alkyl chain.

Examples here are trimethylolethane (R═CH₃) or trimethylolpropane (R═CH₂CH₃). The inventive ester mixtures can comprise esters of two or more different trimethylolalkanes. The radical R particularly preferably derives from trimethylolpropane.

The radical R¹ preferably derives from aromatic monocarboxylic acids, such as benzoic acid, o-toluic acid, m-toluic acid, p-toluic acid, 4-tert-butylbenzoic acid, 1-naphthoic acid or 2-naphthoic acid, in particular from benzoic acid.

The radical R² preferably derives from aliphatic monocarboxylic acids, such as 2-ethylhexanoic acid, caprylic acid, caprinic acid, lauric acid, myristic acid, palmitic acid, stearic acid, oleic acid, arachinic acid or behenic acid, in particular from lauric acid.

The ratios by weight present of the substances mentioned in the plasticizer mixture of the inventive TPUs, based on the entire plasticizer mixture, are preferably as follows:
a) from 1 to 30% by weight of a compound of the general formula (I),
b) from 10 to 60% by weight of a compound of the general formula (II),
c) from 10 to 60% by weight of a compound of the general formula (III) and
d) from 1 to 30% by weight of a compound of the general formula (IV).

The substances mentioned are either known or can be prepared by known methods. By way of example, they can be prepared by using the corresponding aliphatic and/or aromatic carboxylic acids to esterify the trimethylolpropanes mentioned. These and other methods are known to the person skilled in the art and are described by way of example in W. Riemenschneider: “Esters, Organic”, Ullmann's Encyclopedia of Industrial Chemistry, Electronic Release, 7th Edition, Chapter 5, Wiley-VCH, Weinheim 2004.

Simple mixing of the substances mentioned can be used to prepare the plasticizer mixture in the inventive TPUs. It is preferably prepared by using a single operation to synthesize the substances obtained and to mix them. This operation includes by way of example the esterification of one or more trimethylolalkanes with a suitable mixture of the corresponding aliphatic and aromatic carboxylic acids.

The acid number of the inventive plasticizer mixture is preferably smaller than or equal to 1 mg KOH/g. Its acid number is preferably smaller than or equal to 0.5 mg KOH/g (see page 13).

Alongside the substances mentioned, other plasticizers can also be present in the inventive plasticizer mixture, examples being monoalkyl esters of benzoic acid, diesters of benzoic acid with mono-, di-, tri- or polyalkylene glycols, esters of monocarboxylic acids with polyols, dialkyl esters of aliphatic dicarboxylic acids, dialkyl esters of aromatic dicarboxylic acids, trialkyl esters of aromatic tricarboxylic acids, phenyl esters of alkanesulphonic acids, alkyl or aryl esters of phosphoric acid, polyesters derived from dicarboxylic acids, and also mixtures thereof. The plastics may preferably comprise trialkyl esters of aromatic tricarboxylic acids as other plasticizers.

According to the invention, other plasticizers to be used with preference are
the monoalkyl esters of benzoic acid, particularly preferably isononylbenzoate, for example
the benzoic diesters of mono-, di-, tri- or polyalkylene glycols, particularly preferably propylene glycol dibenzoate, diethylene glycol dibenzoate, dipropylene glycol dibenzoate, triethylene glycol dibenzoate or polyethylene glycol dibenzoate and in particular mixtures thereof,
esters of monocarboxylic acids with polyols, particularly preferably esterification products obtainable from benzoic acid, from butyric acid and from glycerol, esterification products obtainable from benzoic acid, from lauric acid and from glycerol, esterification products obtainable from benzoic acid, from lauric acid and from diethylene glycol, or esterification products obtainable from benzoic acid, from lauric acid and from neopentyl glycol,
the dialkyl esters of aliphatic dicarboxylic acids, particularly preferably di(2-ethylhexyl) adipate, diisononyl adipate, di(2-ethylhexyl)sebacate, di(2-ethylhexyl)azelate, diisononyl cyclohexane-1,2 dicarboxylate,
the dialkyl esters of aromatic dicarboxylic acids, particularly preferably di(2-ethylhexyl) phthalate, diisononyl phthalate, diisodecyl phthalate, benzyl butyl phthalate, benzyl isooctyl phthalate, benzyl isononyl phthalate,
the trialkyl esters of aromatic tricarboxylic acids, particularly preferably trioctyl trimellitate,
the phenyl esters of alkanesulphonic acids, particularly preferably the product Mesamoll® from LANXESS Deutschland GmbH,
the alkyl or aryl esters of phosphoric acid, particularly preferably tri(2-ethylhexyl) phosphate, diphenyl 2-ethylhexyl phosphate, diphenyl cresyl phosphate or tricresyl phosphate,
polyesters, particularly preferably polyesters obtainable from dicarboxylic acids, such as adipic acid or phthalic acid, and from diols, such as 1,2-propanediol, 1,3-butanediol, 1,4-butanediol or 1,6-hexanediol.

The hardness of conventional TPUs whose Shore A values are by way of example from 95 to 80 can be lowered via addition of the selected plasticizers that can be used according to the invention to from 80 to 60, and at the same time here there is a marked improvement in elastomeric properties in comparison with unmodified TPU. Surprisingly, it was also possible to improve compression set, residual elongation values and rebound velocity when comparison is made with unmodified TPUs.

The amounts used of the plasticizer mixture suitable according to the invention, which is preferably liquid at 23° C., and of TPU, are preferably such that the Shore A hardness of the elastomeric TPUs is smaller than 85 and that they comprise from 1 to 50 parts by weight, preferably from 3 to 40 parts by weight and in particular from 10 to 40 parts by weight, of the plasticizer mixture selected according to the invention and from 99 to 50 parts by weight, preferably from 97 to 60 parts by weight and in particular from 90 to 60 parts by weight, of TPU.

The invention also provides a process for production of soft, elastomeric TPU preparations via mixing of from 50 to 99% by weight of a TPU with from 1 to 50% by weight of a plasticizer mixture comprising trimethylolalkane esters of aromatic carboxylic acids, trimethylolalkane esters of aliphatic carboxylic acids and trimethylolalkane esters of both aromatic and aliphatic carboxylic acids at temperatures of from 25 to 250° C.

The preferably liquid plasticizer mixture which can be used according to the invention can be added by various methods to the TPUs. By way of example, the plasticizer mixture can be mixed with the structural components (1) to (4), preferably (2) and/or (3), in such a way that the inventive TPUs are prepared in the presence of the plasticizers.

In another variant of the process, the plasticizer mixture can be added during polyurethane preparation to the reaction mixture whose reaction is not yet entirely complete.

The plasticizer mixture which can be used according to the invention is particularly preferably introduced into the TPU whose Shore A hardness is 80 or greater after its reaction has been completed and, if appropriate, after it has been pelletized. Possible methods of adding the plasticizer mixture here are application in a drum mixer, preferably in a heatable horizontal mixer, to pelletized TPU and simultaneous heating, preferably to from 50 to 60° C. The plasticizers are particularly preferably incorporated at temperatures of from 180 to 220° C. into the TPU by way of the melt with the aid of extruders which, if appropriate, have specific devices, such as metering pumps.

The inventive TPUs are used for production of foils and of mouldings, preferably of profiles and of pipes. They are particularly suitable for production of gasket profiles, e.g. for window gaskets and for door gaskets, and for sealing lips. They can also be used, for example, for production of shoe soles, ski boots, grips, ear tags for animals, hoses, cable sheathing, medical items and automobile parts.

The invention is further illustrated by the examples below, but these are not intended to restrict the invention.

### EXAMPLES

The parts stated are based on weights.

Materials Used

Plasticizers: Inventive plasticizer mixture (see Inventive Example 1)
   Butyl benzyl phthalate (Unimoll® BB from LANXESS Deutschland GmbH)
   Dipropylene glycol dibenzoate (Benzoflex® 9-88 from Velsicol Corp.)
   Diphenyl cresyl phosphate (Disflamoll® DPK from LANXESS Deutschland GmbH)
   Phenyl alkylsulphonate (Mesamoll® from LANXESS Deutschland GmbH)
TPUs: Polyester TPU (Desmopan® 385 E from Bayer MaterialScience AG)
   Polyether TPU (Desmopan® 9385 from Bayer MaterialScience AG)

### Inventive Example 1

Preparation of Plasticizer Mixture

268.4 parts of trimethylolpropane, 439.6 parts (180 mol %, based on 100 mol % of trimethylolpropane) of benzoic acid as aromatic monocarboxylic acid and 480.8 parts (120 mol %, based on 100 mol % of trimethylolpropane) of lauric acid as aliphatic monocarboxylic acid, and 120 parts of xylene as entrainer were melted in a 4-necked flask with stirrer, contact thermometer, water separator, reflux condenser and heating mantel with regulator, under a slow-moving stream of nitrogen. 3.4 parts of titanium tetraisopropoxide were added as catalyst and the mixture was boiled at 190° C. for 25.5 h, with stirring. After this time, 103 parts of water had separated. The volatile constituents were removed at 190° C. and 3 mbar within a period of 3 h. The reaction product was isolated and its constitution and physical properties were determined (see below).

Constitution of Plasticizer Mixture

The constitution of the ester mixture was determined via proton NMR spectroscopy. For this, the signals of the CH₂ groups of the trimethylolpropane radicals were integrated, and the relative molar contents of the individual components were calculated from the integrals. The parts by weight of the components can be calculated from the molar contents with the aid of the molar masses, and are given as per cent by weight (% by weight) in Table 1.

TABLE 1
Constitution of plasticizer mixture from Inventive Example 1

| Component | % by weight |
|---|---|
| Trimethylolpropane tribenzoate | 17 |
| Trimethylolpropane dibenzoate monolaurate | 42 |
| Trimethylolpropane monobenzoate dilaurate | 33 |
| Trimethylol propane trilaurate | 8 |

Table 1 shows that ester mixtures of inventive constitution can be prepared in a simple manner by the inventive preparation process via suitable selection of the ratios of the starting materials to one another.

Physical Properties of Plasticizer Mixture

The most important physical data for the inventive plasticizer mixture were determined by the following methods:
Viscosity: to DIN 53015 (2001) by means of Höppler falling-ball viscometer
Acid number: to EN ISO 3682 (1998)
Volatility: Determination of weight loss on heating plasticizer to 130° C. for 6 h, using a Brabender H-A-G, E′ moisture tester

The results are listed in Table 2 together with the data for the non-inventive comparative plasticizers.

TABLE 2
Physical properties of plasticizers used

| | Acid number | Viscosity | Volatility |
|---|---|---|---|
| Plasticizer | (mg KOH/g) | mPas (23° C.) | (%) |
| Plasticizer mixture from | <1.0 | 371 | 0.5 |
| Inventive Example 1 | | | |
| Benzyl butyl phthalate (BBP) | <1.0 | 50 | 1.5 |
| Dipropylene glycol dibenzoate | <1.0 | 150 | 1.5 |
| Diphenyl cresyl phosphate | <1.0 | 40 | 1.8 |
| Phenyl alkylsulphonate | <1.0 | 100 | 1.4 |

All of the plasticizers studied feature acid numbers smaller than 1 mg KOH/g and viscosities smaller than 1 000 mPas, and are therefore suitable in principle for use in TPU. The inventive plasticizer mixture from Inventive Example 1 is characterized by particularly low volatility.

### Inventive Example 2 and Comparative Examples C1-C5

Preparation of Inventive TPU Preparation in Pellet Form

The inventive plasticizer mixture from Inventive Example 1 was incorporated into a TPU preparation in the quantitative proportions stated in Tables 3-6. To produce the TPU preparation, a Haake (Polylab System) extruder was used; tooling: twin screw; rotation rate 100 rpm with heating zone at 170-180-190-190-185° C. The extrudant was pelletized after cooling. Plasticizer-free TPU pellets, and also TPU pellets with the non-inventive comparative plasticizers, were produced in the same way.

### Inventive Examples 3-11 and Comparative Examples C6-C8

Processing to Give Test Specimens

The pellets were used to produce test specimens for determination of Shore hardness A to DIN 53 505. First, a milled sheet was manufactured from the pellets by means of a roll mill (Polymix 80 T; temperature 170° C.; time: 10 min). The milled sheet was then comminuted and charged to a suitable mould. The test specimens were produced by using a press (Polystab 200 T) at 175° C. for 10 min.

The resultant test specimens were aged for 7 days at 100° C. in an oven with air circulation, in order to check exudation behaviour. A sheet of blotting paper was placed on the test specimens. After the ageing process, there was no discolouration on the contact surface of the paper in the case of any of the specimens. This shows that the plasticizer does not migrate back to the surface.

Fogging

The extruded, plasticized TPU pellets (polyether TPU) were studied to determine fogging behaviour to DIN 75201 B. Table 3 gives the measured amount of fogging condensate after 16 hours at 100° C.

TABLE 3
Fogging values for compounded TPU materials

| | | Amounts of | Fogging |
|---|---|---|---|
| | | plasticizer | condensate |
| | | (parts per 100 | (mg/10 g of |
| Example | Plasticizer in TPU pellets | parts of TPU) | specimen) |
| C1 | TPU without plasticizer | 0 | 0.3 |
| 2 | Plasticizer mixture from | 30 | 0.3 |
| | Inventive Example 1 | | |
| C2 | Benzyl butyl phthalate | 30 | 8.0 |
| C3 | Dipropylene glycol dibenzoate | 30 | 24.0 |
| C4 | Diphenyl cresyl phosphate | 30 | 3.0 |
| C5 | Phenyl alkylsulphonate | 30 | 9.0 |

When comparison is made with the plasticizer-free TPU pellets, there is no increase in the amount of fogging condensate from the inventive TPU pellets. This verifies that the plasticizer mixture from Inventive Example 1 has low volatility, high thermal stability, and good compatibility with the TPU. In contrast, the comparative plasticizers gave rise to markedly higher amounts of fogging condensate.

Shore Hardness

Table 4 (polyester TPU) and Table 5 (polyether TPU) show the results of measurement of Shore hardness A to DIN 53 505.

TABLE 4
Amounts of plasticizer used, based on 100 parts of TPU, and
Shore hardness A of compounded polyester TPUs

| | Example | | | | | |
|---|---|---|---|---|---|---|
| | C6 | 3 | 4 | 5 | 6 | C7 |
| TPU (Desmopan ® 385 E) | 100 | 100 | 100 | 100 | 100 | 100 |
| Plasticizer mixture from | 0 | 5 | 20 | 30 | 40 | 0 |
| Inventive Example 1 | | | | | | |
| Benzyl butyl phthalate | 0 | 0 | 0 | 0 | 0 | 20 |
| Shore A hardness | 82 | 77 | 75 | 72 | 67 | 77 |

The data in Table 4 verifies that the plasticizing action of the inventive ester mixture from Inventive Example 1 is comparable with that of benzyl butyl phthalate (Comparative Example C7).

TABLE 5
Amounts of plasticizer used, based on 100 parts of TPU,
and Shore hardness A of compounded polyether TPUs

| | Example | | | | | |
|---|---|---|---|---|---|---|
| | C8 | 7 | 8 | 9 | 10 | 11 |
| TPU (Desmopan ® 9385) | 100 | 100 | 100 | 100 | 100 | 100 |
| Plasticizer mixture from | 0 | 5 | 10 | 20 | 30 | 40 |
| Inventive Example 1 | | | | | | |
| Shore A hardness | 85 | 79 | 74 | 71 | 68 | 63 |

The Shore hardness A of the untreated TPU is 85 (Comparative Example C8). Addition of the plasticizer mixture from Inventive Example 1 achieves greater flexibility, without migration of the plasticizer back to the surface.

What is claimed is:

1. A polyurethane preparation comprising from 50 to 99% by weight of a polyurethane and from 1 to 50% by weight of a plasticizer mixture comprising trimethylolalkane esters of aromatic carboxylic acids, trimethylolalkane esters of aliphatic carboxylic acids and trimethylolalkane esters of both aromatic and aliphatic carboxylic acids.

2. A polyurethane preparation according to claim 1, wherein the polyurethane is a thermoplastic polyurethane elastomer.

3. A polyurethane preparation according to claim 2 comprising
A) from 50 to 99% by weight of a thermoplastic polyurethane elastomer based on polyesterols or on polyetherols, produced from
1) organic diisocyanates,
2) substantially dihydric polyhydroxy compounds with molar masses of from 500 to 8 000 g/mol, and
3) chain extenders with molar masses of from 60 to 400 g/mol, and
B) from 1 to 50% by weight of a plasticizer mixture comprising trimethylolalkane esters of aromatic carboxylic acids, trimethylolalkane esters of aliphatic carboxylic acids and trimethylolalkane esters of both aromatic and aliphatic carboxylic acids.

4. A polyurethane preparation according to claim 3, wherein the plasticizer mixture comprises at least
a) one compound of the general formula (I) 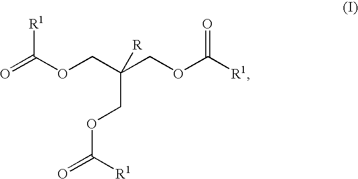
in which
R is H or a C₁-C₄-alkyl chain and
R¹ is a C₆-C₁₄-aryl radical, unsubstituted or substituted with from one to three C₁-C₄-alkyl radicals,
b) a compound of the general formula (II) 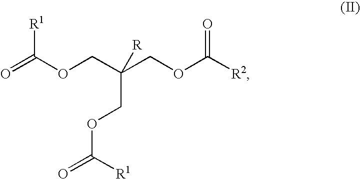
in which
R and R¹ are as defined above and
R² is a straight-chain or branched C₇-C₂₁-alkyl radical,
c) a compound of the general formula (III) 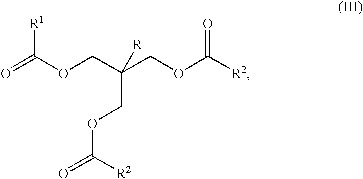
in which
R, R¹ and R² are as defined above and
d) a compound of the general formula (IV) 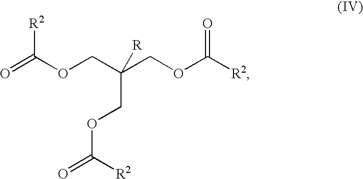
in which
R and R² are as defined above.

5. A polyurethane preparation according to claim 4, wherein the radical R¹ derives from aromatic monocarboxylic acids, such as benzoic acid, o-toluic acid, m-toluic acid, p-toluic acid, 4-tert-butylbenzoic acid, 1-naphthoic acid or 2-naphthoic acid.

6. A polyurethane preparation according to claims 4 and/or 5, wherein the radical R² derives from aliphatic monocarboxylic acids, such as 2-ethylhexanoic acid, caprylic acid, caprinic acid, lauric acid, myristic acid, palmitic acid, stearic acid, oleic acid, arachinic acid or behenic acid, in particular from lauric acid.

7. A polyurethane preparation according to any of claims 4 to 6, wherein the radical R derives from a trimethylolalkane of the general formula (V) 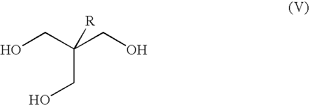
in which
R is H or a C₁-C₄-alkyl chain.

8. A polyurethane preparation according to any of claims 4 to 7, wherein the plasticizer mixture comprises, based on the entire plasticizer mixture,
a) from 1 to 30% by weight of a compound of the general formula (I),
b) from 10 to 60% by weight of a compound of the general formula (II),
c) from 10 to 60% by weight of a compound of the general formula (III) and
d) from 1 to 30% by weight of a compound of the general formula (IV),
and the radicals R, R¹ and R² in the formulae (I) to (IV) are defined as in claim 4.

9. A polyurethane preparation according to any of claims 2 to 8, wherein they also comprise auxiliaries, additives and/or fillers.

10. A process for production of the polyurethane preparations according to claim 1, wherein from 50 to 99% by weight of a polyurethane, are mixed with from 1 to 50% by weight of a plasticizer mixture comprising trimethylolalkane esters of aromatic carboxylic acids, trimethylolalkane esters of aliphatic carboxylic acids and trimethylolalkane esters of both aromatic and aliphatic carboxylic acids at temperatures of from 25 to 250° C.

11. A process according to claim 10, wherein such polyurethane is a thermoplastic polyurethane elastomer.

12. A method of use of the polyurethane preparation according to claim 1 for the production of foils, of ear tags for animals, of mouldings, of pipes, of hoses, of cable sheathing, of profiles, of gaskets, of shoe components and of automobile parts.
